(19) United States
(12) Patent Application Publication
(10) Pub. No.: US 2014/0254168 A1
(43) Pub. Date: Sep. 11, 2014

(54) REMOTE PLASMA LAMP POLE SYSTEM AND METHOD FOR INSTALLING THE SAME

(71) Applicant: Green de Corp. Limited, Hong Kong (HK)

(72) Inventors: Wai Kit Andy LAM, Hong Kong (HK); Yun Kwan William CHAN, Hong Kong (HK)

(73) Assignee: Green de Corp. Limited, Hong Kong (HK)

(21) Appl. No.: 14/166,868

(22) Filed: Jan. 29, 2014

Related U.S. Application Data
(60) Provisional application No. 61/773,839, filed on Mar. 7, 2013.

(51) Int. Cl. F21S 8/08

(52) U.S. Cl. CPC F21S 8/085
USPC 362/294; 362/308; 362/297; 29/428

(57) ABSTRACT

A remote plasma lamp pole system includes a lamp pole, a remote plasma lamp mounted inside a lower portion of the lamp pole, and a reflector mounted inside an upper portion of the lamp pole above the plasma lamp for reflecting light emitting therefrom towards an area to be illuminated. A lens is mounted in front of the first reflector for refracting light therefrom. A fixture is provided to fix therein the reflector and the lens. A method for installing a lamp pole system is also disclosed.

### CROSS-REFERENCE TO RELATED APPLICATIONS

This application claims the benefit of U.S. provisional patent application No. 61/773,839 filed Mar. 7, 2013, the entire content of which is hereby incorporated by reference.

### FIELD OF THE TECHNOLOGY

The present application relates generally to a lamp pole system, and particularly to a remote plasma lamp pole system. The present application also relates to a method for installing a lamp pole system.

### BACKGROUND

Traditional outdoor lamp pole system such as street light, parking light, area light, and landscaping light system installs light source and control gear inside a lighting fixture mounted at the top or the upper part of a lamp pole or column. This consumes a lot of time and resources to hire truck-mounted elevators for regular inspection, maintenance and lamp replacement. The affected streets, road lanes, and surrounding areas have to be temporarily blocked. These inspection, maintenance and replacement works are likely to cause serious traffic disruption.

### SUMMARY

According to one aspect, there is provided a remote plasma lamp pole system including a hollow lamp pole, a remote light module mounted inside a lower portion of the lamp pole and provided with a plasma lamp, a first reflector mounted inside an upper portion of the lamp pole above the plasma lamp for reflecting light emitting therefrom towards an area to be illuminated, a first lens mounted in front of the first reflector for refracting light therefrom, and a fixture for fixing therein the first reflector and the first lens. The fixture may be in the form of a cap mounted at a top open end of the lamp pole. The cap may be formed with a hood extending outwardly beyond the lamp pole and a hood opening facing the area to be illuminated. The hood opening may be mounted with a first lens for refracting light from the first reflector. The remote plasma lamp pole system may further include a second reflector mounted around the plasma lamp and a second lens mounted in front of the plasma lamp for reflecting and collimating light emitting from the plasma lamp towards the first reflector.

According to another aspect, there is provided a lamp pole system including a lamp pole, a light source mounted at a lower portion of the lamp pole, and a first reflector mounted on the lamp pole above the light source for reflecting light emitting therefrom towards an area to be illuminated. The lamp pole system may further include a fixture for fixing therein the first reflector at an angle facing the area to be illuminated.

In one embodiment, the fixture may be in the form of a cap mounted on a top open end of the lamp pole. The cap may be formed with a hood extending outwardly beyond the lamp pole and a hood opening facing the area to be illuminated. The hood opening may be mounted with a first lens for refracting light from the first reflector.

The light source may include plasma lamp, high-intensity discharge lamp, light-emitting diode, organic light-emitting diode, carbon-cathode plasma lamp, field-induced polymer electroluminescent, or high-lumen lamp.

In one embodiment, the lamp pole system may further include a second reflector mounted around the light source and a second lens mounted in front of the light source for reflecting and collimating light emitting from the light source towards the first reflector. The second reflector may include parabolic reflector, elliptical reflector or free-form reflector, and the second lens may include fused silica lens, quartz lens and glass lens.

In one embodiment, the lamp pole system further include at least one light collimator mounted between the light source and the first reflector for re-collimating light emitting from the light source towards the first reflector.

In one embodiment, the lamp pole system may further include a relay lens mounted between the light source and the first reflector for relaying light emitting from the light source towards the first reflector.

In one embodiment, the lamp pole may have a hollow interior and a reflective inner surface. The reflective inner surface may include a reflective material such as reflective aluminum, silver-coated aluminum or nano-coating paint.

In one embodiment, the first reflector can be mounted at an upper portion of the lamp pole. In another embodiment, the first reflector can be mounted at a middle portion of the lamp pole.

In one embodiment, the light source can be mounted on an outer surface of the lamp pole, and the first reflector can be mounted on the outer surface of the lamp pole above the light source. The first reflector mounted on the outer surface of the lamp pole may be adjustable.

In one embodiment, the lamp pole system may further include an outwardly extending pole extension and a pole coupler for coupling the pole extension to the lamp pole. The pole coupler may include an upwardly extending portion coupled with a top open end of the lamp pole and an outwardly extending portion coupled with a proximal end of the pole extension. The lamp pole system may further include a fixture mounted at a distal end of the pole extension for fixing therein a third reflector for reflecting light from the first reflector mounted inside the pole coupler towards the area to be illuminated. The fixture may include a hood with a hood opening facing the area to be illuminated. The hood opening can be mounted with a third lens for refracting light from the third reflector.

In one embodiment, the lamp pole system may further include a heat sink formed on the lamp pole adjacent to the light source for dissipating heat generated therefrom.

According to another aspect, there is provided a method for installing a lamp pole system. The method may include the steps of installing a light module with a light source at a lower portion of a lamp pole, and installing a reflector on the lamp pole above the light source for reflecting light emitting therefrom towards an area to be illuminated.

Although the lamp pole system is shown and described with respect to certain embodiments, it is obvious that equivalents and modifications will occur to others skilled in the art upon the reading and understanding of the specification. The lamp pole system in the present application includes all such equivalents and modifications, and is limited only by the scope of the claims.

### BRIEF DESCRIPTION OF THE DRAWINGS

Specific embodiments of the lamp pole system will now be described by way of example with reference to the accompanying drawings wherein:

FIG. 1 is a sectional view of a remote plasma lamp pole system which is root-mounted or flange-plate-mounted on the ground according to an embodiment of the present application.

FIG. 2 is a sectional view of the remote plasma lamp pole system with two reflectors according to an embodiment of the present application.

FIG. 3 is a sectional view of the remote plasma lamp pole system of FIG. 1 with an additional reflector mounted at a middle portion of the lamp pole according to an embodiment of the present application.

FIG. 4 is a sectional view of the remote plasma lamp pole system having a pole extension coupled with the lamp pole by a coupler according to an embodiment of the present application.

FIG. 5 is a sectional view of the remote plasma lamp pole system with a remote plasma lamp module and a reflector mounted outside the lamp pole according to an embodiment of the present application.

FIG. 6 is a sectional view of the remote plasma lamp pole system according to a further embodiment of the present application.

### DETAILED DESCRIPTION

Reference will now be made in detail to a preferred embodiment of the lamp pole system, examples of which are also provided in the following description. Exemplary embodiments of the lamp pole system are described in detail, although it will be apparent to those skilled in the relevant art that some features that are not particularly important to an understanding of the lamp pole system may not be shown for the sake of clarity.

Furthermore, it should be understood that the lamp pole system is not limited to the precise embodiments described below and that various changes and modifications thereof may be effected by one skilled in the art without departing from the spirit or scope of the protection. For example, elements and/or features of different illustrative embodiments may be combined with each other and/or substituted for each other within the scope of this disclosure and appended claims.

In addition, improvements and modifications which may become apparent to persons of ordinary skill in the art after reading this disclosure, the drawings, and the appended claims are deemed within the spirit and scope of the protection.

It should be noted that throughout the specification and claims herein, when one element is said to be “coupled” or “connected” to another, this does not necessarily mean that one element is fastened, secured, or otherwise attached to another element. Instead, the term “coupled” or “connected” means that one element is either connected directly or indirectly to another element or is in mechanical or electrical communication with another element.

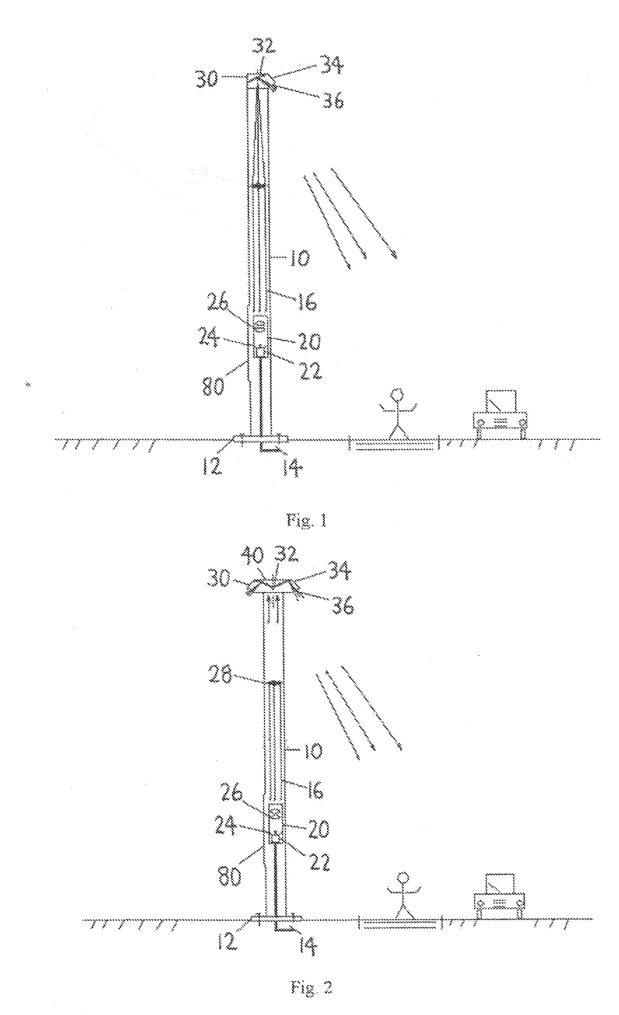

FIG. 1 is a sectional view of a remote plasma lamp pole system according to an embodiment of the present application. The remote plasma lamp pole system may include a hollow lamp pole or column 10. The lamp pole 10, having a base 12, may be root-mounted or flange-plate-mounted on the ground. An incoming main power cable 14 can be used to supply power to the lamp pole 10. A remote light module 20 may be mounted at a lower portion of the lamp pole 10. The light module 20 can be provided with a light source 22.

The lamp pole system of the present application is designed to relocate and integrate the light source 22 to a lower part of the lamp pole 10, forming the so-called remote light module 20. There is no lamp bulb or control gear at the top or upper part of the lamp pole 10. This can reduce maintenance and replacement cost. Moreover, this would not cause any road blockage during maintenance and replacement of the lamp pole 10. Therefore, no traffic disruption would exist. Collimated light 16 can be transmitted from the remote light module 20 through air as light transmission media inside the lamp pole 10 to the top of the lamp pole 10, and then re-distribute to the road surface or open space. The remote light module 20 can be mounted at a lower part of the lamp pole 10 so that it can be accessed easily. The light source 22, such as a plasma lamp, can produce continuous full visible light spectrum like the sunlight to improve the visual and lighting performance. It can result in more electrical energy reduction than traditional high intensity discharge lamp. This will offer great benefit to people and environment.

Plasma lamp source provides extremely bright, broadband light spectrum, good color rendering and is useful in applications such as general illumination, projection systems, and industrial processing. It does not suffer from deterioration of the electrodes that has long rated life time. In addition, plasma lamp source can result in more electrical energy saving than traditional high pressure sodium or HID lamps. Unlike the traditional light bulb which can block much light output, the small-sized plasma lamp as a point source can maximize the efficiency of optics and reflector design.

A preferred light source for the lamp pole system of the present application is electrodeless plasma lamp source. Other kinds of light source such as High Intensity Discharge Lamp (HID), light-emitting diodes (LED), organic light-emitting diode (OLED), Carbon-cathode Plasma Lamp, Field-induced Polymer Electroluminescent (FIPEL), and high-lumen lamp sources can also be used.

A first or upper reflector 32 may be mounted at an upper portion of the lamp pole 10 inside a reflector/lens fixture 30 for reflecting light emitting from the light source 22 towards an area to be illuminated. A first or upper lens 36 may be mounted inside the fixture 30 and in front of the upper reflector 32 for refracting light therefrom.

The reflector/lens fixture 30 may be in the form of a cap mounted on a top open end of the lamp pole 10. The cap may be formed with a hood 34 extending outwardly beyond the lamp pole 10, and a hood opening facing the area to be illuminated. The upper lens 36 may be mounted at the opening of the hood 34 for refracting light from the upper reflector 32 towards an area to be illuminated. The fixture 30 can be made of mild steel, stainless steel, aluminum, alloy, acrylic, or polycarbonate.

The light module 20, including the light source 22 and conventional driver and control gear, may be mounted at a lower portion of the lamp pole 10. Light from the light source 22 can be collimated by a second or lower reflector 24 and a second or lower lens or lens assembly 26. The lower reflector 24 may be mounted around the light source 22 for reflecting light emitting from the light source 22 towards the upper reflector 32. The lower lens or lens assembly 26 may be mounted in front of the light source 22 for collimating light emitting from the light source 22 towards the upper reflector 32.

The lower reflector 24 can be a parabolic reflector, an elliptical reflector, a free-form reflector or any other suitable reflector. The lower lens or lens assembly 26 may include fused silica lens, quartz lens, glass lens, or any other suitable lens.

Collimated light 16 can be directed to light transmission media through air inside the lamp pole 10.

The lamp pole 10 may have a hollow interior and a reflective inner surface. The reflective inner surface may have a reflective material such as reflective aluminum, silver-coated aluminum, nano-coating paint or any other suitable reflective material. The reflective inner surface can reduce light bounce back and can maximize light transmission efficiency towards the top of the lamp pole 10.

Apart from light collimator, relay lenses reflective surfaces, fiber optical cable and liquid light guide may also be used in order to deliver the collimated light from the lower part of the lamp pole 10 to the top of the lamp pole 10 in an effective way.

The reflector/lens fixture 30, which does not contain any lamp source or control gear, can receive the collimated light from the light source 22. When the light passes through the upper reflector 32 and the upper lens 36, the light can form into a new optical light beam with high efficiency or high light output ratio for distribution to an area to be illuminated. The lamp pole system of the present application can be applied to many kinds of lighting such as street, parking, pathway, pedestrian pathway, landscaping and area lightings. Also, the reflector 32 and refracting lens 36 inside the fixture 30 can be defined and applied to lamp poles of different heights.

Inside the remote light module 20, one or more light sources 22 can be used. The remote light module 20 may include a combinations of internal reflector, refractor, filter and lenses configured to collimate light from a wide spread light source to a narrow light beam angle. This can utilize the light from the light source 22 in an efficient way and can minimize loss of light. The light output of the light source 22 can deliver a narrow light beam upwards to the top of the lamp pole 10.

The light source 22, such as a plasma lamp, can be mounted horizontally, at different tilted angles, or vertically upwards or downwards. The light source 22 can be interchangeable with other light sources.

A heat sink 80 may be integrally formed on the lamp pole 10 adjacent to the light source 22 for dissipating heat generated therefrom through conduction, convention, or radiation.

It is understood that the remote light module 20 can be easily accessible by workers working at the lower end of the lamp pole 10 for maintenance and inspection purposes.

One can also install the lamp pole system of the present application on an existing lamp pole. To begin, a worker can install the light module 20 at a lower portion of the lamp pole 10. The light module 20 can be provided with the light source 22, such as a plasma lamp. The reflector 32 can be installed on the lamp pole 10 above the light source 22 for reflecting light emitting therefrom towards an area to be illuminated. The reflector 32 can be provided inside the reflector/lens fixture 30 so that the fixture 30 together with the reflector 32 can be mounted on a top open end of the lamp pole 10. One or more light collimators 28 can also be installed between the light source 22 and the reflector 32 to collimate light from the light source 22 towards the reflector 32. It is understood that the light module 20 and the reflector 32 can be installed on an outer surface of the lamp pole 10.

The lamp pole 10 may be made of mild steel, stainless steel, aluminum, alloy, acrylic, or polycarbonate. The body of the lamp pole 10 can be transparent, translucent, or opaque material. The shape of the lamp pole 10 can be configured in a cylindrical shape, a rectangular shape, a square shape, a triangular shape, a polygon shape, an oval shape, or any combination of these shapes.

The remote plasma lamp pole system of the present application can be programmable and/or dimmable using analog, digital or remote wireless control that allows a user to adjust the lighting at a desired level. The lamp pole system can also be equipped with photocell and occupancy sensor in order to yield excellent energy saving.

FIG. 2 is a sectional view of the lamp pole 10 according to another embodiment of the present application.

One or more light collimators 28 may be mounted between the light module 22 and the upper reflector 32 for re-collimating light emitting from the light source 22 towards the upper reflector 32.

The fixture 30 may be interchangeable with other fixtures having different shapes and optical devices so as to produce different lighting effects. There may be one or more fixtures 30 provided on the lamp pole 10. Each fixture 30 can be tilted and adjustable. Two fixtures 30 may be formed into a single fixture 40. It is understood that the fixture 30 can also be mounted at different levels of the lamp pole 10.

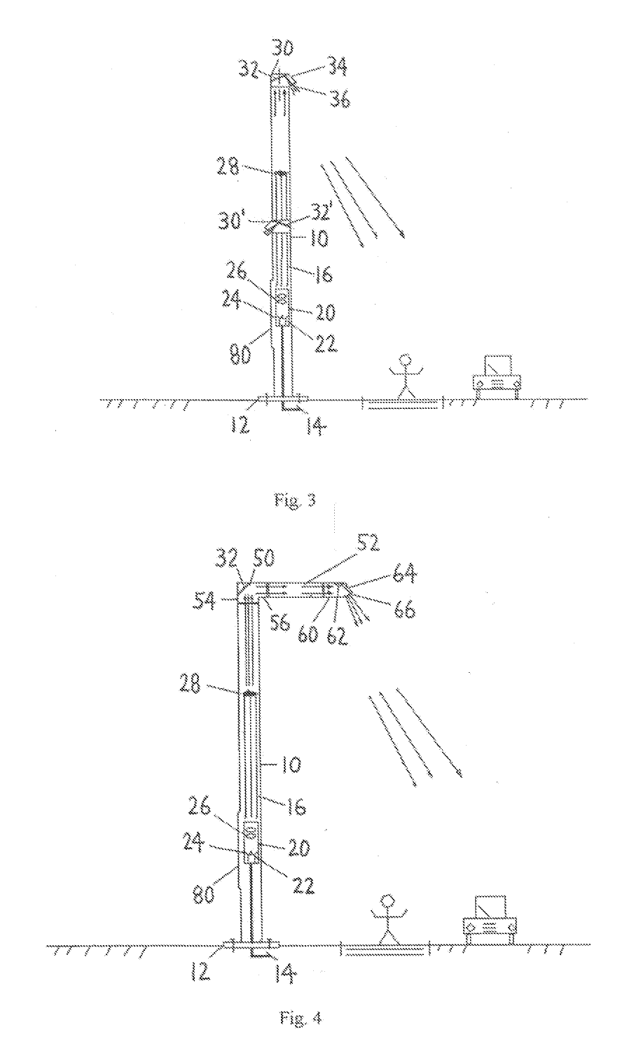

FIG. 3 is a sectional view of the lamp pole 10 of FIG. 1 with a middle reflector 32′ provided inside a middle fixture 30′ mounted at a middle portion of the lamp pole 10 according to another embodiment of the present application. It is understood that the fixture 30 can be fixed at the top of lamp pole 10 as well as at any suitable different levels of lamp pole 10. In use, the upper fixture 30 with the upper reflector 32 can be mounted at the top of the lamp pole 10 for illuminating street area; and the middle fixture 30′ with the middle reflector 32′ can be mounted at a middle portion of the lamp pole 10 for illuminating pedestrian pathway.

FIG. 4 is a sectional view of the lamp pole 10 according to another embodiment of the present application. The lamp pole 10 may further include an outwardly extending pole extension 52 and a pole coupler 50 for coupling the pole extension 52 to the lamp pole 10. The pole coupler 50 may have an upwardly extending portion 54 coupled with a top open end of the lamp pole 10 and an outwardly extending portion 56 coupled with a proximal end of the pole extension 52.

A fixture 60 can be mounted at a distal end of the pole extension 52 for fixing therein a third or outward reflector 62 for reflecting light from the upper reflector 32 mounted inside the pole coupler 50 towards an area to be illuminated. The fixture 60 may include a hood with a hood opening facing the area to be illuminated. A third or outward lens 66 may be mounted at the hood opening for refracting light from the outward reflector 62.

The direction of the collimated light reaching the top of the lamp pole 10 can be changed at a certain angle of up to 90 degrees by using the pole coupler 50. Suitable reflector, lens and/or prism may be fixed inside the pole coupler 50. The pole extension 52 may have different lengths and the distance between the pole coupler 50 and the fixture 60 may vary so as to suit street and road lanes with different widths.

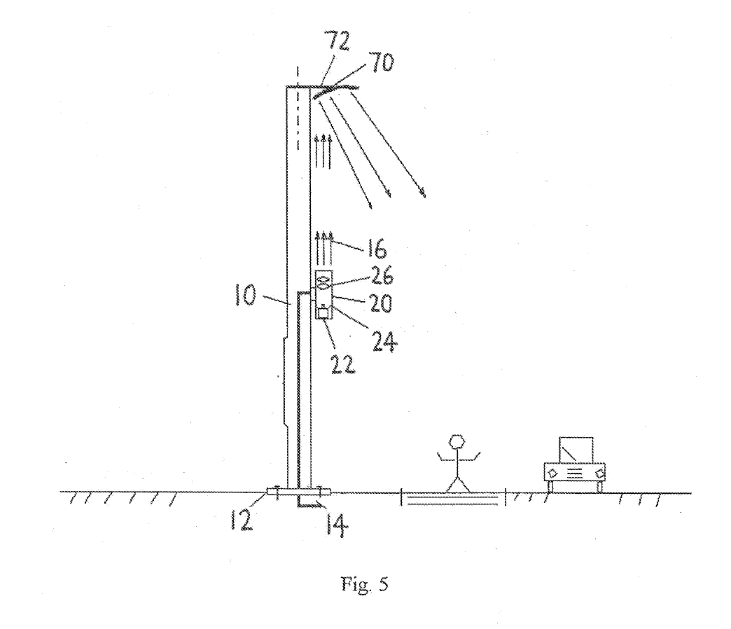

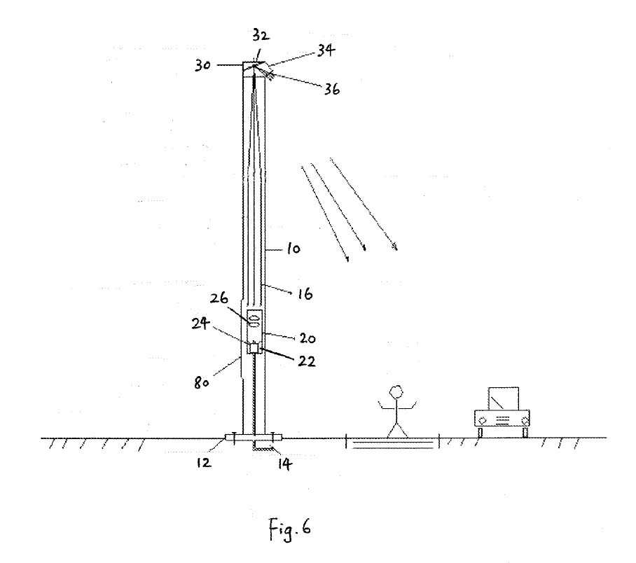

FIG. 5 is a sectional view of the lamp pole system according to another embodiment of the present application. In this embodiment, the remote plasma lamp module 20 can be mounted on an outer surface of the lamp pole 10. The plasma lamp module 20 can be adjusted and fixed at different mounting level. The collimated light can be projected from the module 20 to the top of an external-mounted reflector 70 connected with the lamp pole 10 by an outwardly extending bar 72. The light can then be reflected by the reflector 70 to an area to be illuminated. The external-mounted reflector 70 can be tilted and adjustable for projecting light to an area to be illuminated.

FIG. 6 is a sectional view of the remote plasma lamp pole system according to a further embodiment of the present application. In this embodiment, no light collimator is provided between the light module 22 and the upper reflector 32 for collimating light emitting from the light source 22 towards the upper reflector 32. The upper reflector 32 may reflect light directly from the light source 22 as well as light that may be reflecting from the inner surface of the lamp pole 10.

While the lamp pole system has been shown and described with particular references to a number of preferred embodiments thereof, it should be noted that various other changes or modifications may be made without departing from the scope of the appended claims.

What is claimed is:

1. A remote plasma lamp pole system comprising:
(a) a hollow lamp pole;
(b) a remote light module mounted inside a lower portion of the lamp pole, the light module being provided with a plasma lamp;
(c) a first reflector mounted inside an upper portion of the lamp pole above the plasma lamp for reflecting light emitting therefrom towards an area to be illuminated, and a first lens mounted in front of the first reflector for refracting light therefrom; and
(d) a fixture for fixing therein the first reflector and the first lens, wherein the fixture is in the form of a cap mounted at a top open end of the lamp pole, the cap being formed with a hood extending outwardly beyond the lamp pole and a hood opening facing the area to be illuminated, the hood opening being mounted with a first lens for refracting light from the first reflector.

2. The remote plasma lamp pole system as claimed in claim 1, further comprising a second reflector mounted around the plasma lamp and a second lens mounted in front of the plasma lamp for reflecting and collimating light emitting from the plasma lamp towards the first reflector.

3. A lamp pole system comprising:
(a) a lamp pole;
(b) a light source mounted at a lower portion of the lamp pole; and
(c) a first reflector mounted on the lamp pole above the light source for reflecting light emitting therefrom towards an area to be illuminated.

4. The lamp pole system as claimed in claim 3, further comprising a fixture for fixing therein the first reflector at an angle facing the area to be illuminated.

5. The lamp pole system as claimed in claim 4, wherein the fixture is in the form of a cap mounted on a top open end of the lamp pole, the cap being formed with a hood extending outwardly beyond the lamp pole and a hood opening facing the area to be illuminated, the hood opening being mounted with a first lens for refracting light from the first reflector.

6. The lamp pole system as claimed in claim 3, wherein light source is selected from the group consisting of plasma lamp, high-intensity discharge lamp, light-emitting diode, organic light-emitting diode, carbon-cathode plasma lamp, field-induced polymer electroluminescent, and high-lumen lamp.

7. The lamp pole system as claimed in claim 3, further comprising a second reflector mounted around the light source and a second lens mounted in front of the light source for reflecting and collimating light emitting from the light source towards the first reflector.

8. The lamp pole system as claimed in claim 7, wherein the second reflector is selected from the group consisting of parabolic reflector, elliptical reflector and free-form reflector; and wherein the second lens is selected from the group consisting of fused silica lens, quartz lens and glass lens.

9. The lamp pole system as claimed in claim 3, further comprising at least one light collimator mounted between the light source and the first reflector for re-collimating light emitting from the light source towards the first reflector.

10. The lamp pole system as claimed in claim 3, further comprising a relay lens mounted between the light source and the first reflector for relaying light emitting from the light source towards the first reflector.

11. The lamp pole system as claimed in claim 3, wherein the lamp pole has a hollow interior and a reflective inner surface.

12. The lamp pole system as claimed in claim 11, wherein the reflective inner surface comprises a reflective material selected from the group consisting of reflective aluminum, silver-coated aluminum and nano-coating paint.

13. The lamp pole system as claimed in claim 3, wherein the first reflector is mounted at an upper portion of the lamp pole.

14. The lamp pole system as claimed in claim 3, wherein the first reflector is mounted at a middle portion of the lamp pole.

15. The lamp pole system as claimed in claim 3, wherein the light source is mounted on an outer surface of the lamp pole, and the first reflector is mounted on the outer surface of the lamp pole above the light source.

16. The lamp pole system as claimed in claim 15, wherein the first reflector is adjustable.

17. The lamp pole system as claimed in claim 3, further comprising an outwardly extending pole extension and a pole coupler for coupling the pole extension to the lamp pole, wherein the pole coupler comprises an upwardly extending portion coupled with a top open end of the lamp pole and an outwardly extending portion coupled with a proximal end of the pole extension.

18. The lamp pole system as claimed in claim 17, further comprising a fixture mounted at a distal end of the pole extension for fixing therein a third reflector for reflecting light from the first reflector mounted inside the pole coupler towards the area to be illuminated, wherein the fixture comprises of a hood with a hood opening facing the area to be illuminated, the hood opening being mounted with a third lens for refracting light from the third reflector.

19. The lamp pole system as claimed in claim 3, further comprising a heat sink formed on the lamp pole adjacent to the light source for dissipating heat generated therefrom.

20. A method for installing a lamp pole system, the method comprising:
(a) installing a light module at a lower portion of a lamp pole, the light module being provided with a light source; and
(b) installing a reflector on the lamp pole above the light source for reflecting light emitting therefrom towards an area to be illuminated.
